(19) United States
(12) Patent Application Publication
(10) Pub. No.: US 2026/0230848 A1
(43) Pub. Date: Aug. 6, 2026

(54) SYSTEMS, METHODS, AND DEVICES FOR LOW-LATENCY RECONFIGURATION

(71) Applicant: InterDigital Patent Holdings, Inc., Wilmington, DE (US)

(72) Inventors: Martino M. Freda, Laval (CA); Brian Martin, Farnham (GB); Keiichi Kubota, Tokyo (JP); Samuli Turtinen, Ii (FI); Faris Alfarhan, Montreal (CA); Paul Marinier, Brossard (CA); Tuong Duc Hoang, Montreal (CA); Francois Periard, Montreal (CA); Pascal Adjakple, Great Neck, NY (US); Diana Pani, Montreal (CA); Ghyslain Pelletier, Montreal (CA)

(73) Assignee: InterDigital Patent Holdings, Inc., Wilmington, DE (US)

(21) Appl. No.: 19/046,837

(22) Filed: Feb. 6, 2025

(51) Int. Cl. H04W 24/02; H04B 17/318; H04W 24/10; H04W 76/20

(52) U.S. Cl. CPC H04W 24/02; H04B 17/328; H04W 24/10; H04W 76/20

(57) ABSTRACT

Systems, methods, and devices are described herein that may be associated with low-latency reconfiguration. A wireless transmit/receive unit (WTRU) may receive first event configuration information and/or a first event index associated with the first event configuration information. The WTRU may receive second event configuration information and/or a second event index associated with the second event configuration information. The WTRU may receive a first configuration and/or a first configuration index associated with the first configuration, and/or a second configuration and/or a second configuration index associated with the second configuration. The WTRU may, based on the first condition being satisfied, select the first event index. The WTRU may in response to the selection of the first event index, transmit an indication of the first event index. The WTRU may receive an indication of a configuration index.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, and devices are described herein that may be associated with low-latency reconfiguration (which may, in example, be interchangeably referred to herein as configuration). A wireless transmit/receive unit (WTRU) may include one or more of the following: a processor, a memory, or a transceiver (e.g., a transmitter and/or receiver). The WTRU may be configured to perform one or more of the following. The WTRU may receive (e.g., from a network node, such as a base station) first event configuration information and/or a first event index associated with the first event configuration information. The first event configuration information may indicate a first condition. The WTRU may receive (e.g., from the network node) second event configuration information and/or a second event index associated with the second event configuration information. The second event configuration information may indicate a second condition. The WTRU may receive (e.g., from the network node) a first configuration and/or a first configuration index associated with the first configuration. The WTRU may receive (e.g., from the network node) a second configuration and/or a second configuration index associated with the second configuration. The WTRU may, based on the first condition being satisfied, select the first event index. The WTRU may, in response to the selection of the first event index, transmit (e.g., to the network node) an indication of the first event index. The WTRU may receive (e.g., from the network node and/or after transmission of the indication of the first event index) an indication of a configuration index. The configuration index may indicate the first or the second configuration index.

The first condition may include a data arrival condition and/or a measurement condition. The WTRU may determine that data is available for transmission and/or that a trigger event has occurred. The first condition may be satisfied based on the determination that the data is available for transmission and/or that the trigger event has occurred. The first event configuration information, the first event index, the second event configuration information, the second event index, the first configuration, the first configuration index, the second configuration, and/or the second configuration index may be received via a first control signaling protocol. The indication of the configuration index may be received via a second control signaling protocol. The first condition may include at least one of: an amount of data in a buffer of the WTRU is greater than a threshold, a time remaining for buffering data is less than a first threshold, or a reference signal received power (RSRP) value is greater than a second threshold. The WTRU may determine that data is available for transmission. The WTRU may transmit at least a portion of the data available for transmission using a configuration, from the first or second configurations, associated with the received indication of the configuration index.

The first control signaling protocol may be a dedicated radio resource control (RRC) signaling protocol. The second control signaling protocol may be a MAC control element (CE) protocol. The configuration may indicate an L1/L2 configuration. The configuration index may indicate the first configuration. The WTRU may apply the first configuration (e.g., based on the configuration index indicating the first configuration). The first event index may indicate an event ID. The transmission of the indication of the first event index may include an indication of the event ID.

A method may be performed by a WTRU and/or a network according to one or more features as described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example associated with a configuration including a WTRU and a network.

FIG. 3 is a diagram illustrating an example of a WTRU selecting a configuration.

FIG. 4 is a diagram illustrating an example of a WTRU selecting and/or applying a configuration as part of a configuration.

FIG. 5 is a diagram illustrating an example of a configuration including an index.

FIG. 6 is a diagram illustrating an example signaling for a state transition including a WTRU.

FIG. 7 is a flow diagram illustrating an example configuration that may be performed by a WTRU based on event configuration information.

### DETAILED DESCRIPTION

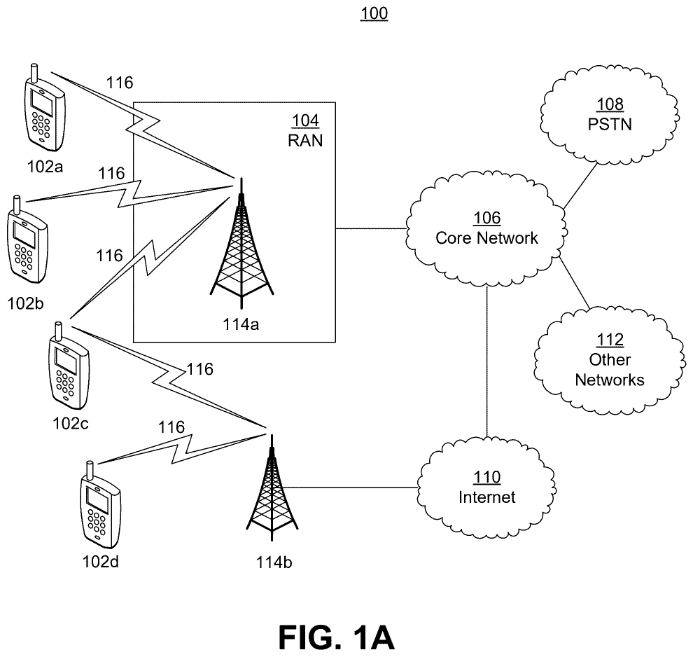

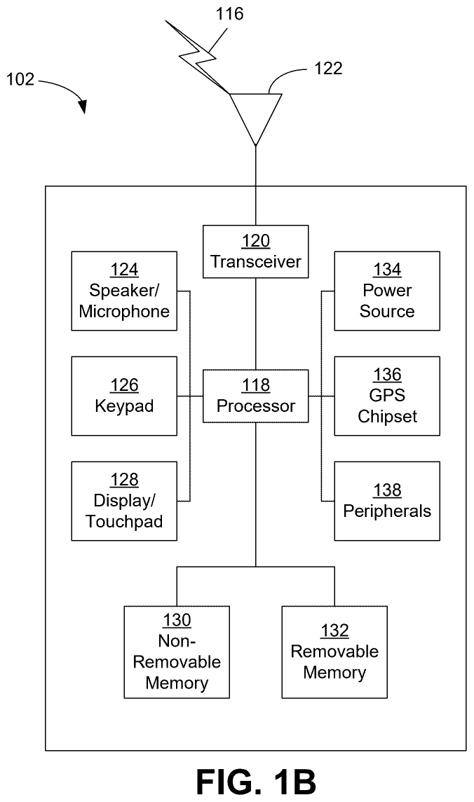

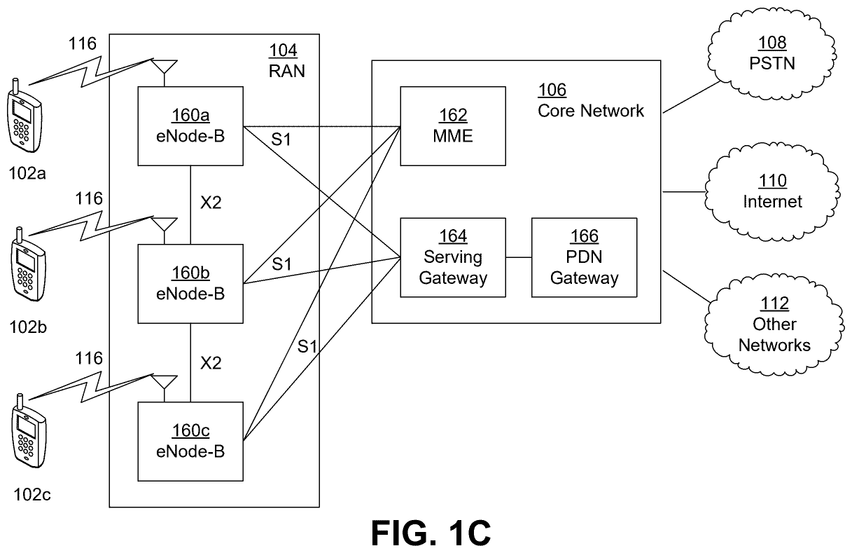

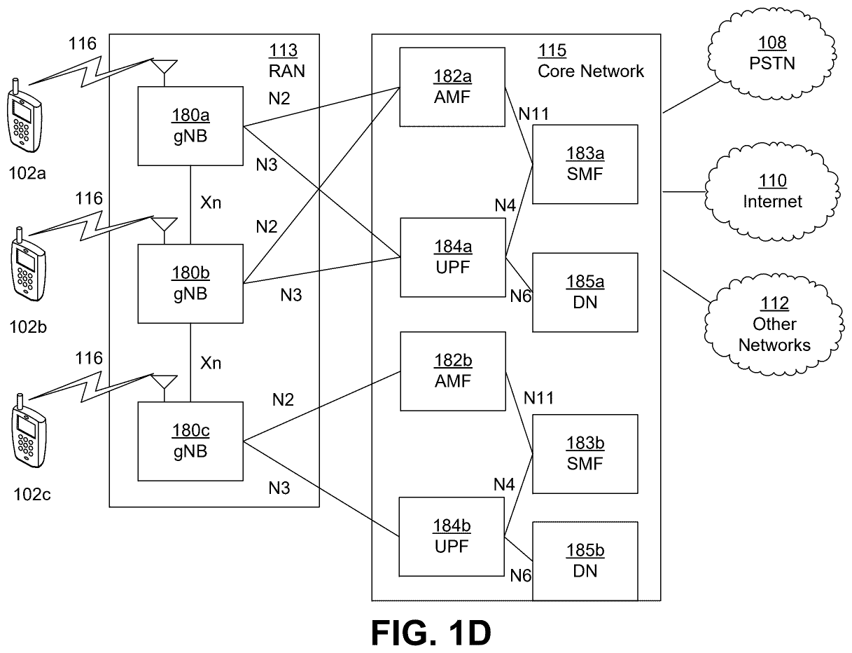

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

A reconfiguration (e.g., interchangeably referred to herein as a configuration) in NR may be described herein.

Mobility in NR may be based on an RRC reconfiguration. In an RRC reconfiguration, a WTRU may receive an RRC message with a full configuration of the (e.g., all possible) RRC parameters, or a delta configuration that may change one or more (e.g., only certain) RRC parameters (e.g., leaving the parameters not included to be unchanged compared to the currently stored/applied configuration).

Mobility in NR may be described herein.

In a handover, a WTRU may receive an RRC configuration of the target cell in the handover command. The RRC configuration may be a full configuration or delta configuration, and/or the RRC configuration may represent the WTRU's configuration to use in the target cell.

To reduce the latency associated with L3 mobility, NR may introduce L1/L2 mobility (LTM). In LTM, the WTRU may receive a list of candidate cell configurations in advance of a handover (e.g., before the handover). The cell switch command may be issued with a cell ID, and/or the WTRU may use the cell configuration that the WTRU has stored for the respective cell.

Examples of network parameters may be described herein.

In mobility, to deal with latency associated with connected mode mobility (HO) and the resulting HO failures, a network may (e.g., 5G) introduce a conditional handover (CHO). A CHO may be used to eliminate the latency associated with measurement reporting. Additional latency may be reduced by introducing L1/L2 triggered mobility (LTM), where the HO may be signaled by, and/or measurements may be performed by, the lower layers. However, in examples such mechanism maybe applied (e.g., may only be applied) if/when the WTRU is being controlled by the network.

A problem in a network may be the latency and/or overhead associated with state transitions between IDLE/INACTIVE and CONNECTED. A network may introduce an RRC_INACTIVE state as a power-saving, that may reduce the latency of state transitions (e.g., compared to IDLE-CONNECTED transitions in LTE). To enable applications to (e.g., further) reduce the latency and/or signaling overhead associated with data transmission, SDT may be introduced as an example, to allow data to be exchanged if in an RRC_INACTIVE state. SDT may not be optimized for data transfer (e.g., SDT may be complex and/or limit in the amount of data that may be transmitted, resulting in limited support of the feature).

One or more features described herein may be associated with a system that enables low-latency reconfigurations for same cell scenarios, and/or allows fast system re-entry between an active and inactive state without the signaling overhead associated with an RRC state transition.

A WTRU operating according to a first configuration may determine a second configuration if/when triggered with a configured data event (e.g., the WTRU may determine a second configuration if/when one or more conditions indicated in event configuration information is satisfied). The WTRU may determine (e.g., select) the second configuration based on a received index/reference indicating a configuration (e.g., the WTRU may determine the second configuration based on a configuration index indicating a configuration from a list of potential second configurations).

A WTRU may perform a connection establishment procedure, for example using a first control signaling protocol (e.g., RRC).

A WTRU may receive (e.g., via a first control signaling protocol (e.g., a dedicated RRC signaling)), a configuration for one or more upper protocol layers (e.g., a DRB configuration, mapping of a QoS flow to a DRB, a PDCP configuration, and/or the like).

A WTRU may receive (e.g., via a first control signaling protocol), an indication of (e.g., a list of) event configurations (e.g., event configuration information) and/or event indexes (e.g., where each event index may correspond to a respective event configuration). Event configuration information may be associated with a condition (e.g., each event configuration may be associated with a respective one or more conditions (e.g., where a condition may be associated with data arriving at a bearer and/or a measurement of the cell/carrier (e.g., during (e.g., at a time associated with)) an event trigger). In examples, event configuration information may indicate condition(s) (e.g., event(s)) such as: event1=data arrives at QoS flow/bearer1 with an amount of the data being greater than a threshold. In examples, event configuration information may indicate condition(s) (e.g., event(s)) such as::event2=data arrives at QoS flow/bearer2 and a selected cell-level reference signal received power (RSRP) is less than a threshold.

A WTRU may receive (e.g., via a first control signaling protocol) a first configuration and a second configuration (e.g., an indication of (e.g., a list of) L1/L2 configurations) and/or an associated configuration index, e.g., the WTRU may receive a respective configuration (e.g., a respective L1/L2 configuration) and a respective configuration index that corresponds to (e.g., is associated with) the respective configuration. In examples, a first configuration index may be associated with the first configuration and/or a second configuration index may be associated with the second configuration. In examples, a configuration may indicate or include (e.g., a list of configurations may include a respective configuration that indicates): a LCH configuration, a physical downlink control channel (PDCCH) monitoring configuration, reference signal(s) configuration, and/or the like. In examples, a configuration index may include an indication of one or more configurations based on an event index.

The WTRU may, based on a condition associated with the event configuration information being satisfied, perform one or more of the following actions: determine an event index, transmit an indication of the event index, receive an indication of a configuration index, transmit a confirmation message, apply a configuration associated with the received configuration index, and/or transmit/receive data based on the applied configuration.

A WTRU may (e.g., based on arrival of data at the WTRU) determine and/or select (e.g., based on a condition associated with the event configuration information being satisfied), an event index (e.g., the event index that corresponds to the configuration information with the condition(s) being satisfied).

The WTRU may transmit (e.g., using a second control signaling protocol, such as a MAC CE), the determined (e.g., selected) event index to the network. For example, the event index may be transmitted using an access procedure to the cell (e.g., in a MAC CE in MSG 3, in the data part of 2-step random access channel (RACH), and/or the like), or in a control message (e.g., in a MAC CE), for example following the access procedure.

The WTRU may receive (e.g., using the second control signaling protocol), a configuration index indicating a configuration (e.g., one of the provided L1/L2 configurations).

The WTRU may transmit (e.g., in an UL resource) a confirmation message (e.g., in a confirmation MAC CE). The confirmation message may indicate a confirmation that the configuration index has been received and/or that the WTRU has or will apply the associated L1/L2 configuration.

The WTRU may apply the configuration (e.g., the L1/L2 configuration) associated with the received configuration index.

The WTRU may transmit/receive data based on the applied configuration associated with the received configuration index (e.g., transmit/receive data using the L1/L2 configuration).

A network-triggered (re)configuration procedure may be described herein.

A WTRU may, e.g., based on a reception of a triggered message (e.g., a message received from a network node such as a base station, where the message may be or may be included or indicated in a paging message, a DCI, or a MAC CE or the like) and/or if the WTRU is configured with the list of events (e.g., the event configuration information), the WTRU may perform a (re)configuration procedure. The triggered message may indicate or include the WTRU's ID, a configured event ID (e.g., one of the configured event IDs), and/or an indication of an event index.

Based on the reception of the triggered message, the WTRU may perform one or more of the following. The WTRU may select a (e.g., suitable) cell.

The WTRU may transmit (e.g., using a second control signaling protocol (e.g., a MAC CE)) the received event index, e.g., the received event index that corresponds to the received event ID. For example, the event index may be transmitted using an access procedure to the cell (e.g., in a MAC CE in MSG 3, in the data part of 2-step RACH, and/or the like), or the event index may be transmitted in a control message (e.g., in a MAC CE) following the access procedure.

The WTRU may receive (e.g., using the second control signaling protocol), a configuration index indicating a configuration (e.g., one of the provided L1/L2 configurations).

The WTRU may transmit (e.g., in an UL resource) a confirmation message (e.g., a confirmation MAC CE). The confirmation message may indicate a confirmation that the configuration index has been received and/or that the WTRU has or will apply the associated L1/L2 configuration.

The WTRU may apply the configuration (e.g., the L1/L2 configuration) associated with the received configuration index.

The WTRU may transmit/receive data based on the applied configuration associated with the received configuration index (e.g., transmit/receive data using the L1/L2 configuration).

Configuration details (e.g., L1/L2 configuration details) may be described herein.

A configuration (e.g., L1/L2 configuration) may include a parameter associated with a physical layer (PHY), a MAC, or another L1/L2 that may be modified by a configuration function or a procedure.

A configuration may include a L1/PHY configuration. A L1/PHY configuration may include a parameter that may be modified by a PDCCH configuration, a physical uplink control channel (PUCCH) configuration, a control resource set (CORESET) configuration, hybrid automatic repeat request (HARQ) codebook configuration, reference signal configuration, sounding reference signal (SRS) configuration, synchronization signal block (SSB) configuration, channel state information reference signal (CSI-RS) configuration, power control configuration, discontinuous reception (DRX) timers and counters, wake-up signal (WUS) configuration, configuration for operation with non-terrestrial network enhancement service (NES) cells, forward error correction (FEC) error control parameters, and/or the like.

A configuration may include an L2 access configuration. An L2 access configuration may include a parameter that may be modified by a physical random access channel (PRACH) resource, DRX timers and counters, a WUS configuration, a SSB configuration, a SR configuration, a buffer status report (BSR) configuration, a dedicated scheduling request (DSR) configuration, congestion information reporting (e.g., a percentage of a packet to mark) to assist a base station with uplink low latency, low loss, scalable throughput (L4S) explicit congestion notification (ECN) packet marking, integrity and security protection algorithms, and/or the like.

A configuration may include a L2/QoS configuration. A L2/QoS configuration may include a parameter that may be modified by a LCH configuration, a QoS flow configuration, a per-packet QoS treatment configuration, a LCP configuration, MAC CE priorities, QoS flow/bearer to LCH mapping restrictions, packet level erasure error control parameters through automatic repeat request (ARQ), packet level erasure error control parameters through FEC, a per-packet QoS treatment configuration including configuration parameters for computing efficiency, a device/network energy consumption efficiency, an artificial intelligence/machine learning (AI/ML) efficiency (e.g., data efficiency, time efficiency, inference efficiency), and/or the like.

An event configuration and/or a trigger event (e.g., trigger details) may be described herein.

A reconfiguration procedure may be triggered by a configured condition (e.g., a data arrival condition or a measurement condition).

Reconfiguration by the WTRU, or a procedure that triggers reconfiguration may be triggered by an event configured by the network. An event may be configured to the WTRU in (e.g., dedicated) signaling (e.g., during or after connection establishment) so that the event applies (e.g., specifically) to the WTRU. An event may be configured in a cell specific fashion (e.g., in SIB). An event may be (e.g., fully) indicated in a specification, and/or may include component(s) (e.g., thresholds, variables to check, timers, and/or the like) that are indicated in a specification, or a combination thereof (e.g., indicated in a cell specific fashion, a specification, and/or via components).

An event may be based on the arrival of data for transmission at the WTRU. For example, an event may include one or more of the following: an arrival of data from a configured QoS flow; an arrival of data from one or more bearers; an arrival of data associated with a service; an arrival of data associated with QoS tagging; an arrival of one or more protocol control elements; an arrival of an amount of data; or an arrival or detection of a data type.

An event may be based on an arrival of data for transmission including the arrival of (e.g., new) data from a configured QoS flow. For example, one or more QoS flow(s) may be configured to trigger an event if/when data from that QoS becomes available for transmission at the WTRU (e.g., for the first time, after (e.g., new) data was not available for that QoS flow for a period of time).

An event may be based on an arrival of data for transmission including the arrival of (e.g., new) data from a one or more bearers. For example, one or more bearers may be configured to trigger an event if/when data from that bearer becomes available for transmission at the WTRU (e.g., for the first time, after (e.g., new) data was not available for that bearer for a period of time).

An event may be based on an arrival of data for transmission including the arrival of (e.g., new) data that is associated with a service. For example, a WTRU may differentiate the data arrival associated with different services, slices, and/or the like, in the upper layers, and/or may trigger an event based on the arrival of a service (e.g., for the first time, and/or after (e.g., new) data was not available for that service for a period of time).

An event may be based on an arrival of data for transmission including the arrival of data associated with (e.g., a specific) QoS tagging. For example, a WTRU may trigger an event if one or more packets become available for transmission at the WTRU and the packet includes an aspect associated with the QoS values, the QoS profile, and/or the like, (e.g., priority, latency, and/or the like) meets a condition.

An event may be based on an arrival of data for transmission including the arrival of one or more protocol control elements. For example, a WTRU may trigger an event if the WTRU receives one or more protocol control element(s) (e.g., a MAC CE, an RLC control PDU, and/or the like). A control element (e.g., a MAC CE) may include a property (e.g., a PDCP control PDU) indicating the start and/or end of a stream of ciphered/un-ciphered data).

An event may be based on an arrival of data for transmission including the arrival of an amount of data. For example, an (e.g., each) event and/or an event condition(s) may (e.g., further) be conditioned on an amount of data, PDUs, bearers, QoS flows, and/or the like, that may trigger the event. For example, the WTRU may trigger the event if at least X PDUs, X bytes, and/or the like, of data of a configured QoS flow arriving at the WTRU.

An event may be based on an arrival of data for transmission including the arrival or detection of a (e.g., new) data type. A data type may be data in relation with the support of a (e.g., new) service provided by, for example, a next generation RAN (e.g., computing as a service, an AI/ML (e.g., data training, monitoring data, inference, AI/ML models or algorithms)) as a service, and/or the like.

An event may be based on the initiation of a (e.g., new) service, a (e.g., new) level of QoS/QoE, and/or the like, that may be initiated at the WTRU. For example, the initiation may include one or more of the following: a (e.g., new) service initiated by upper layers; a (e.g., new) QoS flow established by upper layers; a (e.g., new) QoE rule initiated by upper layers; a (e.g., new) service slice initiated by upper layers; a switch of a QoE level; the detection of a data packet with (e.g., new) information value or a type of an information value (e.g., where the information value of a packet may be an estimate of the contribution of the packet to the desired QoE level); or an ability to meet (e.g., or not meet) a QoS/QoE level. The initiation examples described herein may be initiated autonomously by the WTRU (e.g., based on a trigger at the WTRU and/or initiated as a result of reception of signaling from upper layers (e.g., NAS, RRC, and/or the like).

An event may be based on the absence of data (e.g., for a period of time or for a number of occurrences of another event). For example, an event may include one or more of the following: the absence of data to be transmitted at the WTRU; the absence of data reception at the WTRU; the absence of data to be transmitted or data reception following the occurrence of a configured number of events; or the absence of an event described herein.

An event may be based on the absence of (e.g., any new) data to be transmitted at the WTRU (e.g., associated with one or more of QoS flow, bearer, or a combination thereof, for a period of time). For example, the WTRU may reset a timer following a (e.g., each) PDU generated for transmission in the uplink. If the timer expires, the WTRU may initiate a reconfiguration procedure.

An event may be based on the absence of data reception at the WTRU (e.g., associated with one or more QoS flow, bearer, or a combination thereof, for a period of time). For example, the WTRU may reset a timer following a (e.g., each) received PDU, a received scheduling event (UL or DL), a received control PDU, and/or the like, associated with a QoS flow or bearer. If the timer expires, the WTRU may initiate a reconfiguration procedure.

An event may be based on the absence of data to be transmitted or data reception following an occurrence of a preconfigured number of events. For example, the WTRU may count the number of events that have occurred since the last reception or transmission of data, and/or may trigger a reconfiguration if a configured number of events occurs prior to a transmission/reception event. The events may include: the reception of control signaling (e.g., a MAC CE), the reception of a synchronization signal (e.g., SSB, CSI, and/or the like), or the reception of a timing signal (e.g., a synchronization timing indication, a periodic or semi-periodic synchronization signal, and/or the like).

An event may be based on the absence of an event as described herein (e.g., for a period of time). For example, an event may include the reception of at least a number of bytes/PDUs of data at the WTRU for transmission (e.g., the number of bytes/PDUs of data may be associated with a bearer). If an event has not occurred for a period of time, the WTRU may trigger a reconfiguration procedure.

An event may be associated with a latency or buffering time of data. For example, an event may include one or more of: a latency of data buffered at the WTRU or a remaining time associated with data.

An event may be associated with a latency of data buffered at the WTRU. For example, a WTRU may trigger a reconfiguration procedure if data (e.g., one or more, or a group, or at least a configured amount of data) has been buffered at the WTRU for at least a configured time period.

An event may be associated with a remaining time associated with data. For example, a WTRU may receive data with a remaining time parameter (e.g., time to live). The WTRU may trigger a reconfiguration procedure if/when the remaining time is less than a threshold.

An event may be based on the amount of data to be transmitted by the WTRU. For example, an event may include one or more of the amount of data in the buffer. For example, a WTRU may trigger a reconfiguration procedure if/when the amount of data (e.g., for a QoS flow, bearer, LCH, and/or a group thereof), buffered at the WTRU is greater than a threshold (e.g., for a time to trigger). For example, a WTRU may trigger a reconfiguration procedure if/when the amount of data (e.g., for a QoS flow, bearer, LCH, and/or a group thereof), buffered at the WTRU is less than a threshold (e.g., for a time to trigger).

An event may be based on measurements of one or more cells, carriers, a group of resources or reference signals transmitted by the network, and/or the like. For example, an event may be based on an RRM or LTM measurement event associated with the serving and/or neighbor cells (e.g., such as Ax events, Bx events, and/or the like). For example an event may be based on an RRM or LTM measurement event associated with a group of cells and/or carriers, where the measurement may include an average among the group of cells and/or carriers, a maximum, a minimum, a difference between the maximum and the minimum, and/or the like.

An event may be based on reception of control or configuration signaling from the network or from an (e.g., another) entity (e.g., another WTRU, an IOT device, and/or the like). For example, a reception of control or configuration signaling may include one or more of the following: a paging or a paging-like trigger received from the network; a change in system information; a reception of an explicit reconfiguration message; or a reception of a request from another device or WTRU.

Control or configuration signaling may include paging or a paging-like trigger received from the network. For example, a WTRU may trigger a reconfiguration procedure based on the reception of a paging message from the network.

Control or configuration signaling may include a change in system information. For example, a WTRU may trigger a reconfiguration procedure based on a change in the system information, which may include: a change in the version of the system information; a change in one or more parameters in the system information (e.g., associated with how the WTRU derives its configuration); or a change in an element of system information that determines how an appropriate configuration for the WTRU is derived for a cell/carrier.

Control or configuration signaling may include the reception of a (e.g., an explicit) reconfiguration message. For example, a WTRU may receive a trigger or a control message (e.g., a MAC CE, an RRC message, and/or the like) that may (e.g., explicitly) trigger the initiation of a reconfiguration procedure as described herein (e.g., based on event configuration information).

Control or configuration signaling may include the reception of a request from a (e.g., another) device or WTRU. For example, a WTRU may receive a request, an indication, an access message, and/or the like, from a WTRU and/or device (e.g., another WTRU or another device) that may trigger the reconfiguration (e.g., for the purposes of the WTRU serving the device or communicating with the device). For example, a request may instruct the WTRU to perform (e.g., based on specified rules, based on a lack of resources, and/or the like) a reconfiguration at the WTRU.

An event may be based on the reception of data from the network, or from an entity (e.g., another entity such as another WTRU, an IOT device, and/or the like). For example, an event may include one or more of the following examples. For example, an event may include the reception of data from another entity that requires forwarding to the network, where the WTRU does not include the capability, resources, configuration, and/or the like, for forwarding the data to the network. For example, an event may include the reception of data from another entity that requires forwarding to the network, where the timing parameters, QoS parameters, and/or the like, request that a reconfiguration is met (e.g., a logical channel request at the WTRU is not yet established or configured). For example, an event may include the reception of data from another entity if/when the remaining time for buffering is less than a threshold.

An event may be associated with a period of time that a condition as described herein (e.g., data, measurements, and/or the like) is satisfied. For example, a condition (e.g., or events indicated herein) may be considered as triggering a reconfiguration procedure if the condition is satisfied for a period of time (e.g., for at least a configured period of time).

An event may be associated with availability of resources (e.g., or the unavailability of sufficient resources) from the network. For example, the WTRU may trigger a reconfiguration procedure based on one or more of the following events: the WTRU does not have a grant available for transmission; or the WTRU does not have a grant with a property(ies) available for transmission.

The property may include one or more of: the size of the grant is at least (e.g., or at most) a size; the slot duration of the grant is at least (e.g., or at most) a duration; the number of resource blocks is at least (e.g., or at most) a value (e.g., number); the grant occurs at a frequency, a cell, a carrier, and/or the like; the grant is associated with a chip length; the grant is associated with resources dedicated for feedback; the grant is associated with a frequency, a set of resources, or a carrier, where the measurements of the frequency, the set of resources, or the carrier meet a criteria; the grant meets a timing parameter with respect to the arrival of data for transmission at the WTRU; or the grant includes a periodicity of at least (e.g., or at most) a duration.

An event may be associated with the occurrence of one or more conditions associated with a WTRU's transmission property or ability to provide a (e.g., other) type of service (e.g., computing as service, AI/ML as a service, hardware, and/or the like). For example, the WTRU may trigger a reconfiguration based on one or more of the following events or conditions described herein.

A condition may be associated with a logical channel prioritization result (e.g., in terms of data being selected from a logical channel in relation to the prioritized bit rate(PBR). For example, the WTRU may trigger a reconfiguration based on the PBR being met for a (e.g., each) logical channel in a grant, and/or the grant still having (e.g., additional) space. For example, the WTRU may trigger a reconfiguration based on the PBR not being met for a logical channel during LCP for one or more grants. For example, the WTRU may trigger a reconfiguration based on a logical channel that is not selected during LCP (e.g., for one or more grants).

A condition may be associated with power reporting. For example, the WTRU may trigger a reconfiguration based on having power headroom reported (e.g., based on a number of times, with a condition associated with content that may be included in the report).

A condition may be associated with SRS reporting. For example, the WTRU may trigger a reconfiguration based on including a SRS reported (e.g., based on a number of times, with a condition associated with what content that may be included in the report).

A condition may be associated with a buffer occupancy. For example, whether a buffer occupancy level of an L2 scheduling queue (e.g., configured for congestion detection and/or reporting to a base station) passes a threshold.

A condition may be associated with percentage to use for packet marking. For example, a change in the percentage to use for packet marking that the WTRU recommends to the base station for L4S ECN marking (e.g., for congestion control of the uplink traffic).

A condition may be associated with a data storage/memory usage level. For example, a data storage/memory usage level may be less than a threshold or greater than a threshold (e.g., in support of task offloading by the WTRU to the network).

A condition may be associated with a remaining computing resource or a computing load. For example, a computing load may be less than a threshold or greater than a threshold (e.g., in support of task offloading by the WTRU to the network).

A condition may be associated with a hardware condition, a thermal/heating condition, or an (e.g., other) operational status condition.

An event may be associated with one or more failures at the WTRU (e.g., associated with an procedure or measurement). For example, the WTRU may trigger a reconfiguration procedure based on one or more of the following events: a radio link failure or similar occurrence at the WTRU (e.g., a number of out of sync, or out of service determinations is greater than a threshold); a beam failure detection (e.g., or similar) at the WTRU; one or more of, or a consecutive number of HARQ feedback failures (NACK, DTX, and/or the like); one or more of, or a consecutive number of ARQ failures (e.g., RLC NACK); or a failure to apply a configuration parameter, a set of configuration parameters, and/or the like, received in a control message (e.g., a MAC, an RRC, and/or the like).

One or more combinations of the events and/or conditions described herein may trigger a reconfiguration procedure. For example, a combination may include triggering a reconfiguration procedure based on the occurrence of one or more events or conditions (e.g., occurring simultaneously). For example, the WTRU may trigger a reconfiguration procedure if the WTRU receives (e.g., new) data from a QoS flow and/or the measurements of the cell is less than a threshold.

For example, a combination may include triggering a reconfiguration procedure if/when a number of events or conditions (e.g., any of a number of events or conditions) are be satisfied. For example, the WTRU may trigger a reconfiguration procedure if the WTRU receives (e.g., new) data from a QoS flow or the measurements of the cell are less than a threshold.

Events may be configured with an entry and/or an exit condition.

In examples, a reconfiguration procedure may be triggered based on an event that includes an entry and an exit condition.

In examples, the triggering of an event may occur if a first condition is met, and/or a time period after the first condition is met, a second condition is met. For example, a WTRU may trigger a reconfiguration if (e.g., new) data associated with a bearer, a QoS flow, or a LCH arrives at the WTRU, and/or prior to the expiry of a timer, the buffer status at the WTRU exceeds a threshold.

In examples, the triggering of an event may occur if a first condition is met, and/or a second condition is not met after at least a period of time. For example, a WTRU may trigger a reconfiguration if (e.g., new) data associated with a bearer, a QoS flow, or a LCH arrives at the WTRU, and/or after the data arrives, if the WTRU has not received a grant with a property.

In examples, the triggering of an event may occur if a first condition is met. Following completion of the reconfiguration procedure, the WTRU may initiate the detection of a second event (e.g., another event, that may not have been monitored previously). If the second event (e.g., the other event) is triggered, the WTRU may trigger a second reconfiguration.

Events may be configured with a prohibit timer (e.g., or similar).

In examples, a WTRU may be configured with a prohibit timer (e.g., or similar) that may disable the triggering of one or more events as a result of a condition if/when a second (e.g., another) reconfiguration has been triggered. For example, based on triggering a reconfiguration, a WTRU may disable the evaluation of a second trigger (e.g., any other trigger) for reconfiguration (e.g., for a configured period of time).

In examples, a WTRU may be configured with a condition (e.g., as described herein) that disables the triggering of a reconfiguration based on an (e.g., another) event(s). The WTRU may disable an event evaluation based on the occurrence of a second (e.g., another) event, or if a condition is satisfied. For example, based on the reception of a reconfiguration message (e.g., from a MAC CE, or from an RRC), the WTRU may disable an event evaluation for triggering a reconfiguration procedure (e.g., the WTRU may disable monitoring for an event based on the reception of a reconfiguration message). For example, the WTRU may disable an event evaluation for triggering a reconfiguration procedure based on resetting of a timer, a counter, and/or the like, that may be associated with an event trigger evaluation.

An event may be triggered by a network (NW) signal.

NW initiated traffic may be handled using a network triggered event. For example, a WTRU may receive network signaling (e.g., a paging message, a DCI, a MAC CE, and/or the like) that may (e.g., explicitly) trigger a reconfiguration procedure. The network may (e.g., explicitly) provide the configuration (e.g., either in the downlink signal or a subsequent signal). In examples, the WTRU may determine an applicable event based on the measurement of a quantity or a condition at the time of reception of the network signal, and/or the WTRU may report the event as per a WTRU triggered event reporting procedure.

An event may be periodic (e.g., based on a periodic timer).

The WTRU may be configured to periodically report a condition periodically (e.g., a computing load to assist in offloading computing decisions or scheduling decisions).

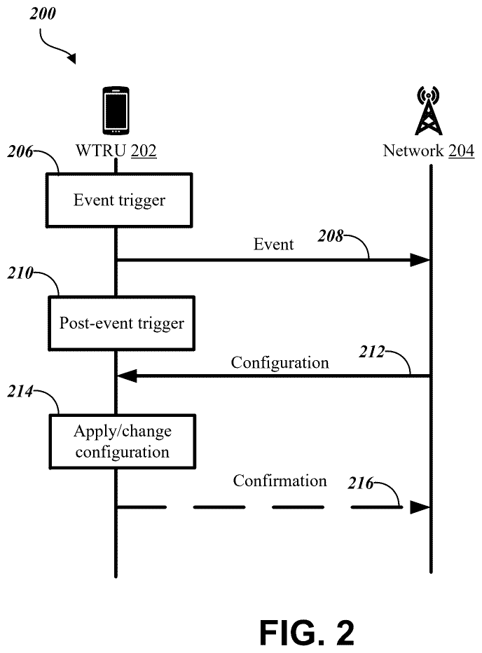

FIGS. 2-6 illustrate example features associated with reconfiguration, where one or more of the illustrated features may be performed.

A reconfiguration may be triggered based on one or more of the events (e.g., and/or conditions) described herein and/or may include one of the following examples (e.g., as illustrated with reference to FIGS. 2-6).

FIG. 2 is a diagram illustrating an example 200 associated with a configuration including a WTRU 202 and a network 204. In examples, a WTRU 202 may trigger 206 the transmission 208 of an event or event indication to the network 204. The transmission 208 of the event or event indication may be included in one or more uplink transmissions. The WTRU 202 may perform an operation 210 with respect to the event following an event reporting (e.g., where an operation 210 may be performed until the reception of a configuration message). The WTRU 202 may receive a configuration 212 or indication of a configuration (e.g., associated with the reported event). Following reception of the indication of the configuration, the WTRU 202 may apply the configuration or apply the associated parameters 214. Optionally, the WTRU 202 may transmit a confirmation message 216, to confirm the application of the configuration (e.g., in an (e.g., additional) uplink message.

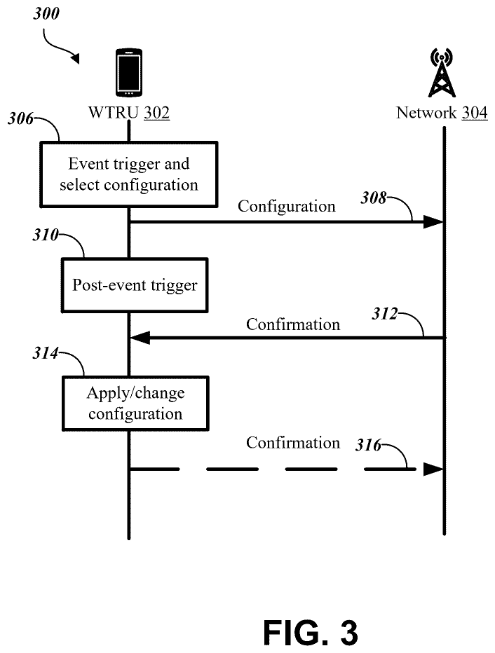

FIG. 3 is a diagram illustrating an example 300 of a WTRU 302 selecting a configuration. As illustrated in FIG. 3, a WTRU 302 may trigger an event and may select a corresponding configuration 306. The WTRU 302 may signal the selected (e.g., or determined) configuration 308 to the network 304. The selected configuration may be indicated in one or more uplink transmission(s). Following transmission of the configuration, the WTRU 302 may perform an operation 310 associated with configuration reporting (e.g., where the operation 310 may be performed until the WTRU 302 receives a configuration message). The WTRU 302 may receive a confirmation message 312 indicating the reported configuration. The WTRU 302 may apply the configuration or apply the associated parameters 314 based on reception of the confirmation message 312. Optionally, the WTRU 302 may transmit a confirmation message 316, to confirm the application of the configuration (e.g., in an uplink message).

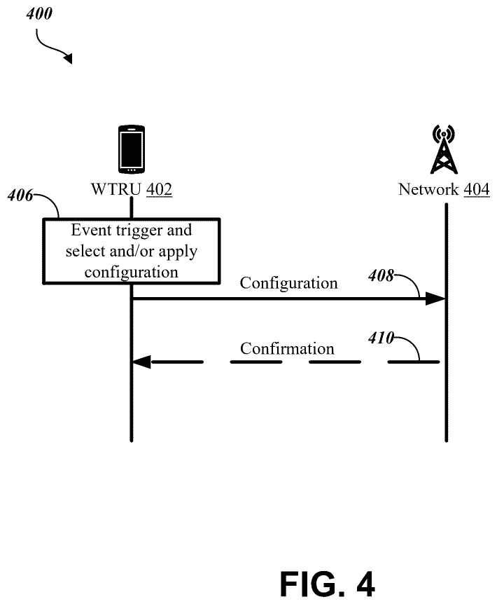

FIG. 4 is a diagram illustrating an example 400 of a WTRU 402 selecting and/or applying a configuration as part of a configuration operation (e.g., procedure). As illustrated in FIG. 4, a WTRU 402 may trigger an event and/or may select a (e.g., corresponding) configuration 406. The triggered event and/or the selected configuration 406 may be indicated in one or more uplink transmissions. The WTRU 402 may apply the configuration (e.g., immediately) and/or may indicate the applied configuration and/or the triggered event 406 to the network 404 in a configuration message 408. Optionally, the network 404 may confirm the application of the configuration in a downlink message 410.

The example 400 illustrated in FIG. 4 may apply to network-initiated configuration changes. For example, in FIG. 2, the network 204 may send a DL signal that triggers an event determination at the WTRU 202. For example, in the example of FIG. 3, an event may not be used and/or the example 300 may start with a network 304 initiated configuration message.

### A Wtru May Select the Configuration.

A WTRU may select the configuration (e.g., reconfiguration) applicable to an event based on one or more of the following: the event (e.g., itself); an aspect or measurement associated with an event; or the WTRU's state or configuration.

The WTRU may select the configuration applicable to an event based on the event (e.g., itself). For example, an event may cause the WTRU to select (e.g., require) a first configuration and/or a second event may cause the WTRU to select (e.g., require) a second configuration.

The WTRU may select the configuration applicable to an event based on an aspect or measurement associated with an event. For example, one or more events associated with a QoS flow may cause the WTRU to select (e.g., require) a first configuration, and another QoS flow may cause the WTRU to select a second configuration.

The WTRU may select the configuration applicable to an event based on the WTRU's (e.g., current) state or configuration. For example, a configuration may be a function of the WTRU's (e.g., current) state (e.g., an RRC state, a MAC activity level, and/or the like), the WTRU's (e.g., current) configuration, the WTRU's (e.g., current) PDCCH monitoring status or frequency, a DRX state, and/or the like.

A WTRU may report an event to the network.

A WTRU may be configured to report a triggered event to the network. The report may identify the event triggered at the WTRU. For example, the WTRU report may include an index to the event (e.g., an event ID). The event ID may be a predefined ID, or a list of configured IDs that may be reported by the WTRU. The WTRU may report an index to a list of events (e.g., an event index) configured at the WTRU (e.g., configured in dedicated RRC signaling, or indicated in a broadcast SIB). For example, the WTRU may provide, in a MAC CE, an index to a list of event configurations provided to the WTRU by an RRC.

In examples, the WTRU may report an event category or an event grouping (e.g., in addition to an event index). For example, a (e.g., each) configured event may include a category, a type, or a grouping, where the category, type, or grouping may be predefined, specified, or configured. For example, the WTRU may include an (e.g., explicit) indication of the type of grouping in the message (e.g., as an enumerated type or an index of categories). A WTRU may (e.g., further) provide one or more levels of grouping(s) or categorization(s) using (e.g., separate) indications in the report. For example, a WTRU may provide an index to an event category of QoS, another index to a sub-event category within QoS of (e.g., new) data received at a bearer, and/or the like.

A WTRU may report (e.g., additional) information about the nature of the event. The information may be dependent on the event (e.g., itself). For example, the WTRU may report a measurement if/when an event is associated with a cell or resource measurement. For example, the WTRU may report a bearer, a QoS flow index, or an identity if/when the event is associated with a condition that is met on a bearer, a QoS flow, a LCH, and/or the like. For example, the WTRU may report a time duration for a condition, if/when the event is associated with a condition occurring for at least a period of time. For example, the WTRU may report a carrier frequency, a bandwidth part, a cell, and/or the like, if/when the event is triggered (e.g., based on one or more examples described herein). For example, the (e.g., additional) information may identify, to the network, the aspect or factor (e.g., described herein) that triggered the event. The WTRU may determine the (e.g., additional) information to report based on a predefined association between an event type and information, or based on a configuration from the network.

Signaling associated with the report may be described herein.

A WTRU may send the report using an L1/L2 control message. For example, the WTRU may transmit the report in a MAC CE. For example, the WTRU may transmit the report on a PUCCH resource.

In examples, the report may be part of an access procedure. For example, the WTRU may initiate a random access procedure and include the report as part of the random access procedure. For example, the WTRU may select a preamble sequence and/or resource configured to indicate a first or a group of events. For example, the WTRU may transmit data with the RACH, where the data may correspond to a control element (e.g., a MAC CE) indicating the event.

In examples, the report may be transmitted as part of an SR/BSR procedure. For example, the WTRU may be configured with a dedicated SR for indicating a first or a group of events.

A WTRU may signal the trigger of an event, the event type, and/or the information about the event (e.g., separately). For example, a first transmission may indicate that an event is triggered, a second transmission may indicate the type of event, and/or the third transmission may indicate information associated with the event. A first transmission may indicate an event type or grouping, and/or a second may indicate the event and/or information associated with the event. For example, in a random access procedure: the WTRU may select a preamble sequence and/or resource associated with the event type or event grouping (e.g., the event type may be sent in MSG1); or the WTRU may (e.g., if it receives MSG2), transmit information associated with the event (e.g., or the event triggered) in MSG3 (e.g., in a MAC CE, and/or RRC message, and/or the like).

The WTRU may associate a priority with the report.

In examples, an event may be associated with a priority (e.g., either explicitly in configuration, or based on condition associated with the occurrence of the event, such as the amount that a threshold was exceeded) that may affect one or more of: the transmission of the event report, the duration of the reconfiguration, the contents of the event report, or the post-event behavior to perform.

The event may be associated with a priority that may affect the transmission of the event report. For example, the MAC CE for transmitting the event report may include a priority in LCP that may be associated with the associated event priority. For example, if/whether the WTRU may trigger a SR may depend on the associated event priority.

The event may be associated with a priority that may affect the duration of the reconfiguration. For example, the WTRU may apply a reconfiguration for a duration, where the duration may be based on the priority associated with the event.

The event may be associated with a priority that may affect the contents of the event report. For example, the WTRU may include, in the event report, an amount of information (e.g., a larger amount of additional information) if/when the event is associated with a higher priority.

The event may be associated with a priority that may affect the post-event behavior to perform. For example, events of a (e.g., different) priority may be associated with a (e.g., different) post-event behavior as described herein.

A WTRU may be configured with post-event trigger behavior.

A WTRU may perform one or more operations as part of post-event trigger behavior in the event configuration procedure(s) described herein. For example, the operations may apply following the transmission of the event indication, and/or the operation may persist until reception of the configuration or a confirmation signaled by the network.

A WTRU may disable one or more event triggering(s) until reception of a network configuration signal or confirmation. A WTRU may disable (e.g., all) events. A WTRU may disable a subset of events, and/or continue to monitor for other events. For example, events may be associated with a priority and the WTRU may disable an event associated with a lower priority than a currently triggered event (e.g., until the WTRU receives network signaling).

A WTRU may trigger an error procedure if a response is not received from the network a period of time following the event trigger/indication. The time period may be (pre)configured. The time period may be based on the event type, the determined priority of the event, the amount that the threshold is exceeded with respect to the event, and/or the like.

A WTRU may retransmit the event indication or the configuration indication a specified or configured number of times prior to triggering an error procedure. The WTRU may wait for a period of time for the response from the network before retransmitting the event indication or configuration indication.

A WTRU may suspend an aspect of the WTRU's operation until receiving the network response. For example, the WTRU may suspend transmission of data associated with a bearer, a LCH, or a QoS flow. For example, the WTRU may disable a WTRU-autonomous mobility or evaluation of the data. For example, the WTRU may disable transmission of a measurement report. For example, the WTRU may suspend transmission of one or more MAC CEs (e.g., such as a BSR, and/or the like).

A WTRU may recommend a post-event trigger behavior/WTRU actions to assist a base station determination of a subsequent command.

A first WTRU may recommend a post-event behavior, an action, or a command the base station may issue back to the first WTRU or to a second WTRU (e.g., the first WTRU is communicating with). A WTRU may make a recommendation as a function of the nature of the event, a priority of the event, a configuration of the event, the WTRU's preference, a channel condition, and/or the like.

A WTRU may select a configuration or range of configurations.

In examples, a WTRU may select a configuration or a range of configurations. For example, the WTRU may select a collection of L1/L2 parameters for operation by the WTRU, where the collection may have been (e.g., previously) configured to the WTRU (e.g., in an RRC message). The WTRU may select a value or a (e.g., potential) range of values for a L1/L2 parameter (e.g., where the parameter may be described herein.

The selection of a configuration aspect may include of one or more of the following: a selection of a configuration (e.g., a set of values for a set of L1/L2 configuration parameters), where the parameters may be from a set of configurations provided by the network (e.g., by an RRC, a SIB, and/or the like) or predefined (e.g., in a specification); a selection of a subset of configuration parameters to change or reconfigure; or a selection of the value(s) or a range of value(s) to use for a L1/L2 parameter.

A WTRU may use one or more of the following criteria for selection of the configuration aspect: an associated with the event, cell/carrier/bandwidth part-specific information, measurements at the WTRU, measurements of the resource quality or usage, a quantity or amount that a condition is satisfied, an assigned priority of the event, based on a measure of quality that may be achieved, a state or collection of configuration aspects, or a (e.g., current) configuration or value of a parameter.

A WTRU may select a configuration aspect based on an association with the event.

For example, a WTRU may be configured (e.g., in RRC) with a configuration aspect for an event or an event trigger. The WTRU may select the configuration aspect based on the configuration.

A WTRU may select a configuration aspect based on a cell/carrier/bandwidth part-specific information transmitted by the network. For example, the WTRU may receive information from the cell, carrier, bandwidth part, and/or the like, which may determine a configuration aspect to select if camped/connected to the cell. For example, the information may include one or more of the following: a cell type or capability (e.g., in the form of an index); a pattern, periodicity, and/or the like of reference signals (SSB, CSI, and/or the like); or a cell ID.

For example, the WTRU may (e.g., be restricted to) select a subset of configuration aspects associated with a cell type, where the cell type may be broadcast in the cell's system information.

For example, the WTRU may be configured with (e.g., or predefined with) an association between a cell type (e.g., broadcast in SIB) and/or a configuration aspect (e.g., a set of allowable L1/L2 parameters). The WTRU may determine a L1/L2 parameter that may be supported by the cell that the WTRU may be camped or connected to.

A WTRU may select a configuration aspect based on measurements at the WTRU (e.g., of cell quality, Ax events, and/or the like). For example, the WTRU may be configured with a subset of configuration aspects for a (e.g., each) cell quality or a range of cell qualities measured by the WTRU.

A WTRU may select a configuration aspect based on a measurement of the resource quality or usage. For example, the WTRU may be configured with a subset of configuration aspects for a (e.g., each) measure or a range of resource utilization (e.g., congestion), RSSI, energy, and/or the like (e.g., that may be associated with a usable transmission resource).

A WTRU may select a configuration aspect based on a quantity or an amount that a condition is satisfied. For example, the WTRU may be configured with an instruction (e.g., a rule) or an association between the level that an event has been met, and/or the configuration aspect that may be selected if/when the event is triggered. For example, the WTRU may select a first set of parameters to be modified and may select the (e.g., specific/allowable) values of the parameters by the amount that the event is satisfied (e.g., a buffer status amount that is greater than the threshold, a measurement value that is greater than the threshold, an amount of time past the trigger time that a condition persists, and/or the like).

A WTRU may select a configuration aspect based on an assigned priority of the event. For example, the WTRU may be configured with a priority between events (e.g., a specific priority or a relative priority between events). The WTRU may select the configuration aspect that may be selected (e.g., or that may be configured) for the priority level of the event.

A WTRU may select a configuration aspect based on a measure of quality that may be achieved following the change in the configuration aspect. For example, the WTRU may compute an expected increase in throughput, an increase in power efficiency, a decrease in latency, and/or the like, as a result of a change in a configuration aspect, and/or may make a selection that at least one of: minimizes the latency, maximizes the performance, minimizes the change in the (e.g., currently) configured value if obtaining at least the requested change in an event characteristic, and/or ensures an improvement in the event conditions by at least (e.g., or at most) a threshold.

A WTRU may select a configuration aspect based on a state or collection of configuration aspects that are associated with or modeled as a state. The collection may consist of PDCCH monitoring status or frequency, mobility mechanism (e.g., if/whether the WTRU may perform autonomous mobility or network controlled mobility), etc.

A WTRU may select a configuration aspect based on a configuration or value (e.g., a current configuration or a current value) of one or more L1/L2 parameters. For example, the WTRU may determine the allowable value for one or more L1/L2 parameters based on the (e.g., current) configuration (e.g., current values being applied). For example, the WTRU may determine to change one or more L1/L2 parameters by (e.g., at most) a threshold amount, by (e.g., at most) one or more values in an ordered list of values, and/or the like.

For example, the WTRU may determine the allowable value for one or more L1/L2 parameters based on the last configuration (e.g., explicitly) provided by the network (e.g., in an RRC, using an explicit configuration in a MAC, and/or the like).

For example, the WTRU may be provided with an ordered association of a (e.g., current) configuration and an allowable (e.g., next) configuration (e.g., in the form of a directed graph), and/or may select from the allowable (e.g., next) configurations. The allowable (e.g., next) configurations may (e.g., further) be based on one or more conditions as described herein.

A WTRU may be configured with a (e.g., different) configuration aspect associated with a (e.g., different) criteria or condition. For example, the WTRU may determine the L1/L2 parameters that may be selected based on the event (e.g., based on an association of an event or an event type to an L1/L2 parameter). The WTRU may determine the configuration value based on a the priority of the event and/or the cell type.

A WTRU may determine if/whether a configuration, a parameter range, and/or the like, may be selected.

In examples, the criteria and/or conditions described herein, for selection of a configuration may be used by the WTRU for determining if/whether to select the WTRU's configuration or if/whether to rely on the network selection. For example, for a configuration of a PDCCH monitoring status, the WTRU may determine the WTRU's configuration selection and may use a first configuration procedure, and/or for a second (e.g., another) PDCCH monitoring status, the WTRU may report the triggered event as part of the configuration procedure and rely on a second configuration procedure.

A WTRU may report a configuration selection to the network.

A WTRU may report a selected configuration to the network as part of the configuration procedure. For example, a WTRU may determine, based on the event, a configuration or set of configuration values for one or more L1/L2 parameters. For example, the WTRU may select a configuration (e.g., one of the allowable configurations) based on a rule or condition (e.g., based on previous rules or conditions). For example, a selection from the configurations (e.g., the allowable configurations) may be random, may be a distance (e.g., the smallest distance) from the WTRU's configuration (e.g., where distance represents the number of changes along a directed map of related configurations) and/or the like, and/or the WTRU may report the selected configuration to the network. For example, the WTRU may select a (e.g., desired) configuration to be reported to the network based on the previous rules, events, conditions, and/or the like.

A WTRU may report a configuration index or identity that may include one or more of: an element in an ordered list of configurations (e.g., received by dedicated RRC signaling or in SIB), where the index n includes the nth element in the list; or an element in an ordered list of configurations predefined or specified (e.g., in specifications).

In examples, a WTRU may report a set of ordered pairs, including a configuration parameter and a corresponding value. For example, the configuration parameter may be a configured or predefined index associated with an L1/L2 parameter; the value may be a value (e.g., an absolute value) for the parameter; or an index of the values allowable based on configuration and/or based on event, based on a cell type, based on a measurement, or based on a condition as described herein.

In examples, a WTRU may report a an event index or identity and a corresponding configuration change index or identity. For example, the WTRU may be configured with a set of configuration changes (e.g., each configuration change) may include one or more rules associated with one or more parameters, such as: an increase parameter x by an amount, a change parameter y to an (e.g., the next largest) allowable value, and/or the like) for each event. The WTRU may report the event index and the corresponding configuration change index that was selected at the WTRU (e.g., based on condition(s) described herein).

Signaling associated with the configuration selection report may be described herein.

A WTRU may send the report using an L1/L2 control message. For example, the WTRU may transmit the report in a MAC CE. For example, the WTRU may transmit the report on a PUCCH resource.

In examples, the report may be included as part of an access procedure. For example, the WTRU may initiate a random access procedure and include the report as part of the random access procedure. For example, the WTRU may select a preamble sequence and/or resource configured to indicate one or more configurations. For example, the WTRU may transmit data with the RACH, where the data may correspond to a control element (e.g., a MAC CE) indicating the configuration.

In examples, the report may be transmitted as part of an SR/BSR procedure. For example, the WTRU may be configured with a dedicated SR for indicating one or more configurations and may provide the configuration (e.g., itself) in a BSR-like MAC CE.

A WTRU may signal an event and the corresponding configuration separately. The WTRU may signal the configuration parameter and the configuration value separately. For example, a first transmission may indicate a first part of the report, a second transmission may indicate the second part of the report. For example, in a random access procedure at least one of: the WTRU may select a preamble sequence and/or a resource associated with the event type or event grouping (e.g., the event type may be sent in MSG1); or the WTRU, if it receives an MSG2, may transmit the selected configuration for the event in MSG3 (e.g., in a MAC CE, and/or an RRC message).

A WTRU may receive a configuration in the form of a reference or index to a set of (pre)configured values.

In examples, a WTRU may receive configuration information in the form of an index, a reference, or a choice that includes one of a (pre)configured set of configurations, configuration values, and/or the like. The aspects related to a configuration message (e.g., the signaling, the format, and/or the like) may (e.g., further) be applied to the configuration information that is transmitted by the WTRU to the network in the case where the WTRU selects its configuration.

In examples, a WTRU may first receive a set of full or partial configuration(s) (e.g., a set of parameters to be configured and the corresponding value(s)) via a SIB, an RRC configuration, a MAC, and/or the like. The WTRU may (e.g., then) receive a configuration in the form of an index (e.g., an index to the set, an index configured as part of each full or partial configuration, an index predefined for each configuration, and/or the like). The WTRU, based on the reception of the index, may apply the values associated with a (e.g., each) parameter in the (pre)configured full or partial configuration referred to by the index.

A WTRU may receive an index that is based on or references parameters related to the event triggered.

In examples, the WTRU may receive an index or reference, where the index or reference may indicate a configuration or change in configuration that is related to or configured for the corresponding event index provided by the WTRU. The WTRU may be configured with one or more event configurations based on conditions/factors described herein. The WTRU may associate (e.g., in addition to the event configuration) a configuration aspect with a (e.g., each) event configuration, where the configuration aspect may include: a set of L1/L2 parameters that may be reconfigured by the network as a result of triggering/indicating the event; a set of L1/L2 parameter values that may be applied by the WTRU for the associated L1/L2 parameters; or a duration to apply the change in the configuration.

For example, the configuration change may apply for an indicated amount of time.

For example, the configuration change may be applied for a number of slots.

For example, the configuration change may be applied if the WTRU transmits or receives an amount of data.

A set of L1/L2 parameters that may be reconfigured by the network as a result of an event may be associated with the event based on a rule (e.g., a predefined or specified rule). For example, an event associated with cell measurements may impact L1/L2 parameters related to power control, MCS, CSI reporting, and/or the like.

A set of L1/L2 parameters that may be reconfigured by the network as a result of an event may be associated with the event based on a configuration provided previously by the network (e.g., in an RRC). For example, as part of the event configuration, the WTRU may receive the L1/L2 parameters (e.g., as a list, as an index referring to a specified list, and/or the like) that may be configured by the network.

A set of L1/L2 parameters that may be reconfigured by the network as a result of an event may be associated with the configuration of an entity that triggered the event. For example, if an event is triggered by a QoS flow, a bearer, or a logical channel, the L1/L2 parameters that are reconfigured may be the QoS flow, the bearer, or the logical channel.

In examples, one or more and/or a combination of the examples described herein may be used to (e.g., further) limit the configuration parameters to be configured by the network based on an event.

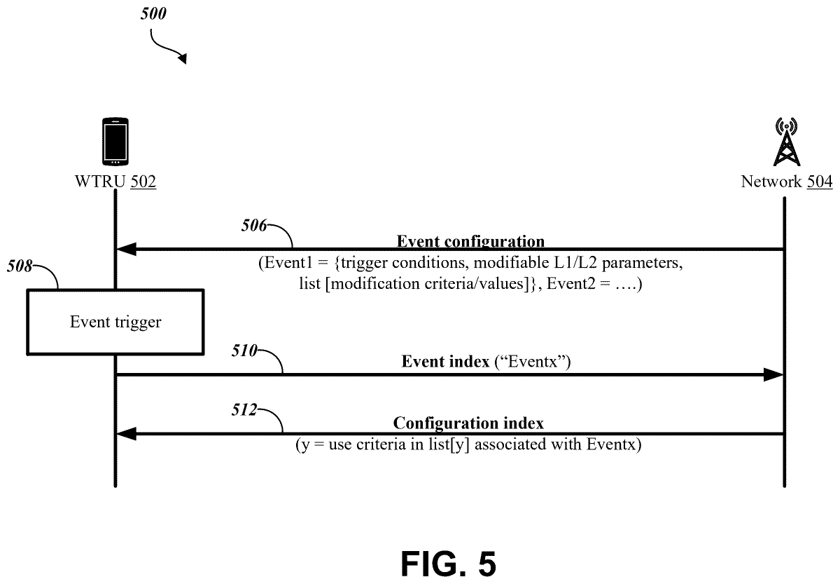

FIG. 5 is a diagram illustrating an example 500 of a configuration including an index. FIG. 5 illustrates an example 500 of a configuration, by the network 504, via a transmission of an index, and/or how the index may be associated with the event configuration. The WTRU 502 may receive (e.g., in RRC signaling) an event configuration 506 that includes one or more events to be configured (e.g., the event configuration may be used to determine the event trigger 508). An event (e.g., each event such as event x) configuration may include: a set of trigger conditions to be applied to determine if/when the event is triggered (e.g., threshold values, and/or the like); an index or indication of the modifiable L1/L2 parameters associated with the event (e.g., such may be explicitly configured and/or may rely on a specification, and/or on an implicit association with the factor that triggered the event, as described herein); and/or a list of modification condition(s) or values. The modification criteria or value may indicate the change in a L1/L2 parameter or set of parameters (e.g., an absolute value, a modification according to a rule, an increase by an amount, and/or the like). The list may include a plurality of modifications or values for the said L1/L2 parameters that the network may configure/instruct in the subsequent configuration index (e.g., all possible modifications and/or a subset thereof may be included).

The WTRU 502 may provide an event index 510 and information to inform the network 504 of the event. Based on the event (e.g., referring to one of “Eventx” of FIG. 5) the WTRU 502 may receive an index 512 that indicates an element in the list of modification criteria or values associated with that event.

The configuration may include one or more indices and/or references.

The WTRU may receive a configuration message including one or more indices/references. For example, the configuration message may include an ordered list of integers or indices.

In examples, a (e.g., each) index may correspond to a selection within a (e.g., separate) list of options. For example, an event or event configuration may be associated with N lists of possible parameter values. For example, a first (e.g., one) list may include a number of options for power control configuration, a second list may include a number of options for reference signal configuration, and/or the like, in a (e.g., specified) or configured (e.g., based on the event triggered) order of the N lists. The configuration may indicate a value for an index in a (e.g., each) list that corresponds to the value(s) to be assigned for the corresponding parameter.

In examples, the configuration message may include a list of indices that identify the parameter(s) to modify based on an ordered list or tree-like structure. For example, the configuration may include the following N-tuple of values: {x1, x2, x3, . . . xn}, where x1 identifies a first family of parameters (e.g., power control parameters), x2 identifies a sub-family of parameters within the power control parameters, and/or so on, and xn indicates the index into a list of value(s) for the parameters identified by the previous N-1 indices. A configuration message may include one or more N tuples to configure one or more sets of parameters of different families/subfamilies. The structure of the families/subfamilies may be configured in RRC signaling or may be predefined in specifications.

In examples, the configuration message may include the absolute value of the parameter to configure. For example, the message may include one or more indices to identify the parameter, followed by the absolute value.

In examples, the configuration message may include an identifier that (e.g., immediately) identifies a set or collection of L1/L2 parameters, and/or an identifier that identifies the combination of values to give to that set of parameters.

A configuration message may use a combination of one or more examples described herein to configure one or more parameters or parameter sets. A configuration message may identify the format used for a set of identifiers (e.g., in a header).

Signaling associated with the configuration index/indication may be described herein.

A configuration index/indication may be received by the WTRU using L1/L2 signaling. For example, the WTRU may receive a MAC CE that includes one or more indices. For example, the WTRU may receive a DCI message that (e.g., explicitly) encodes the indices. For example, a configuration message may be included in a dedicated DCI format used for configuration purposes. For example, a configuration message may be included in a protocol header (e.g., a MAC header) that carries a data PDU.

In examples, the WTRU may receive one or more configuration messages in a (e.g., single) configuration procedure. For example, the WTRU may receive a DCI message that configures aspects of L1, and/or may receive a MAC CE that configures aspects of L2. For example, the WTRU may receive one or more MAC CEs in one or more DL grants, (e.g., each possibly) a DL grant configuring a different set of parameters, (e.g., each possibly) a DL grant transmitted using a different format of indexing as described herein. For example, a DCI message may serve the purposes of both configuring the PHY aspect, and/or allocating grants for the DL grant which includes the MAC CE that configures the L2 aspects.

A WTRU may apply a temporal configuration.

A WTRU receiving a configuration message may apply the (e.g., new) configuration (e.g., change the parameters indefinitely). For example, following application of the (e.g., new) configuration, the WTRU may use the configuration until a subsequent configuration procedure involving a parameter (e.g., the same parameters), or until one or more error conditions described herein occurs.

In examples, a WTRU may apply a configuration indicated in a configuration message (e.g., or confirmed by a NW confirmation message) for a finite period of time. For example, the WTRU may apply the indicated parameters for a period time before falling back to the previous configuration or changing to a default configuration. The time period may be determined based on one or more of the following: a time period indicated by the configuration message; a time period configured by an RRC or predefined in the specification, a time period indicated by the event configuration, or a time period indicated by an exit condition.

The time period may be indicated by the configuration message (e.g., itself). For example, the configuration message may indicate a time period (e.g., seconds, slots, and/or the like) or a value referring to a (pre)configured time period. Based on reception of the configuration message, the WTRU may apply the configuration for the time period provided in the configuration (e.g., itself).

The time period may be configured by RRC or predefined in the specification. For example, the time period may be configured (e.g., at the WTRU in an RRC) prior to reception of the configuration message. For example, a set or family of L1/L2 parameters may be configured in an RRC with a configuration time and the WTRU may apply the received configuration for that amount of time. For example, L1/L2 parameters may be predefined (e.g., in specification) with a time period of application.

The time period may be indicated by the event configuration. For example, the WTRU may determine the time period for applicability of one or more L1/L2 parameters based on the event that triggered the configuration procedure. For example, the time period may be configured in the event configuration. For example, the time period may be a function of the level in which the event was surpassed (e.g., how much the threshold was exceeded by).

A time period may be indicated by an exit condition that may be configured as part of the event configuration.

In examples, an event may be configured with an entry condition and/or an exit condition. For example, a first configuration procedure may be triggered based on an event entry. A second configuration procedure may be triggered based on an exit condition (e.g., associated with the factors as the entry condition). The second configuration procedure may include the (e.g., same) signaling as the first configuration procedure. In examples, the WTRU may be configured to return to the previous configuration, or may be provided with an alternate configuration in the DL configuration message. The second configuration procedure may include an UL indication by the WTRU (e.g., a RACH, a PUCCH, a SR, a MAC CE, and/or the like) indicating to the network the occurrence of the exit condition. The WTRU may fall back to the previous configuration at the transmission of the UL indication. The WTRU may fall back to the previous configuration at the reception of a confirmation signal (e.g., a DL MAC CE, a DCI, and/or the like) that follows the UL indication.

A WTRU may apply a configuration after a time, or after receiving one or more parts.

Radio limitations may make it difficult to receive (e.g., all) of the information associated with a single configuration to be applied in a single DL message (e.g., DCI, MAC CE). It may be advantageous for the network to send the configuration changes in one or more parts, and/or to have the WTRU apply the (e.g., different) parts (e.g., simultaneously, in cases where one or more events may be triggered).

In examples, the WTRU may determine an application time (e.g., a slot or frame boundary a time after reception of a configuration message) to apply a configuration. An application may be configured in an RRC, may be indicated in specifications, or may be dependent on the event or event type. For example, following the reception of a first configuration message, the WTRU may start a timer. A WTRU may receive (e.g., all) configuration messages when the timer is running and apply (e.g., all of) the configuration messages together (e.g., at the same time) rather than one by one. In examples, if/when the timer expires, the WTRU may (e.g., simultaneously) make (e.g., all) changes in the L1/L2 parameters indicated by the messages (e.g., each of the messages).

In examples, the WTRU may receive a marking of associated configuration messages and/or may apply them (e.g., together) based on an (e.g., explicit) indication. For example, the WTRU may receive an ID with a (e.g., each) configuration message, where the configuration messages to be applied (e.g., together) include the same ID. The WTRU may apply the configuration at a time (e.g., a future time based on a timer) or based on reception of an indication (e.g., a last configuration message indication). The WTRU may receive a sequence number with a (e.g., each) configuration message and may apply the changes based on the sequence number. For example, a WTRU may trigger an error procedure if a message in the sequence is not received (e.g., by a certain time).

A WTRU may apply configurations in a sequence based on delta signaling. For example, a first configuration may be applied to parameters a, b, and c (e.g., only) if the configuration message applies (e.g., only) to those parameters, and if a second configuration is applied to parameters c and d (e.g., only if the second configuration applies to parameters c and d. Delta signaling may be applied for one or more parameters (e.g., increase to the next value, decrease to the next value, and/or the like). In examples, the delta signaling may be applied sequentially for the messages (e.g., for each message) in order of sequence number once they have each been received. A configuration may be applied using a (e.g., full) configuration (e.g., for a subset or family of parameters only). For example, based on the reception of values in a message for a, b, and c, in a configuration for a family including of a, b, c, and d, the message may de-configure d for that family (e.g., the message may indicate to remove a configuration associated with d for the WTRU) if the message is determined to provide full configuration. The WTRU may indicate (based on an RRC configuration for the family, the event, or in the signaling) the type of signaling to apply.

An example usage for triggering state transition may be described.

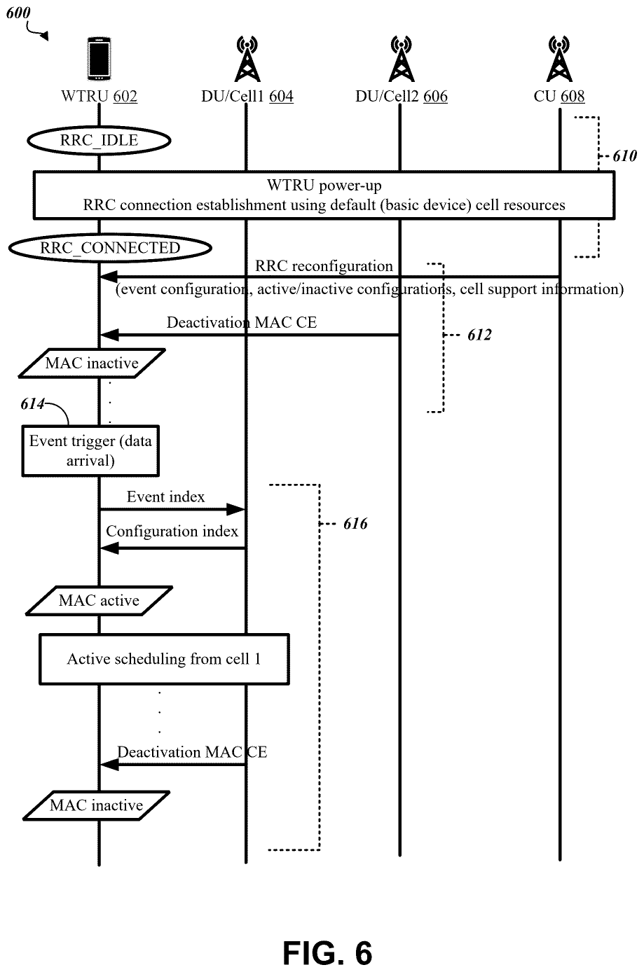

FIG. 6 is a diagram illustrating an example of signaling for a state transition including a WTRU. AN example usage for a L1/L2 configuration may be to provide signaling associated with a state transition. For example, WTRU behavior at L1/L2 may be modeled as one or more MAC states. The MAC states may be separate from the WTRU's RRC connection. For example, a WTRU may initiate an RRC connection using procedures (e.g., using RRC signaling). If the RRC is connected, the WTRU may transition between one or more MAC behaviors (e.g., modeled as different MAC states, such as MAC active or MAC inactive). The states may be associated with one or more (e.g., different) WTRU behavior(s) (e.g., mobility, PDCCH monitoring, power savings, WUS monitoring, and/or the like). The L1/L2 configurations provided in a (e.g., each) state transition signal may include similar configuration procedure(s) described herein (e.g., with an additional indication or different message type).

For example, with reference to FIG. 6, based on a power up, the WTRU 602 may establish an RRC connection via cell 2, 606, at 610. RRC signaling at 612 may be used to configure the events associated with triggering a reconfiguration procedure that may serve as a MAC state change. After triggering the reconfiguration operation, cell 2, 606 (e.g., or cell 1, 604) may trigger a NW initiated L1/L2 configuration procedure to place the WTRU 602 in a MAC inactive state (e.g., as part of 612) when providing an explicit L1/L2 configuration. Based on an event trigger 614, the WTRU 602 may report the event trigger 616 to the network (e.g., cell 1, 604, cell 2, 606, and/or CU 608), which may initiate the reconfiguration procedure and initiate a MAC state change (e.g., at 616).

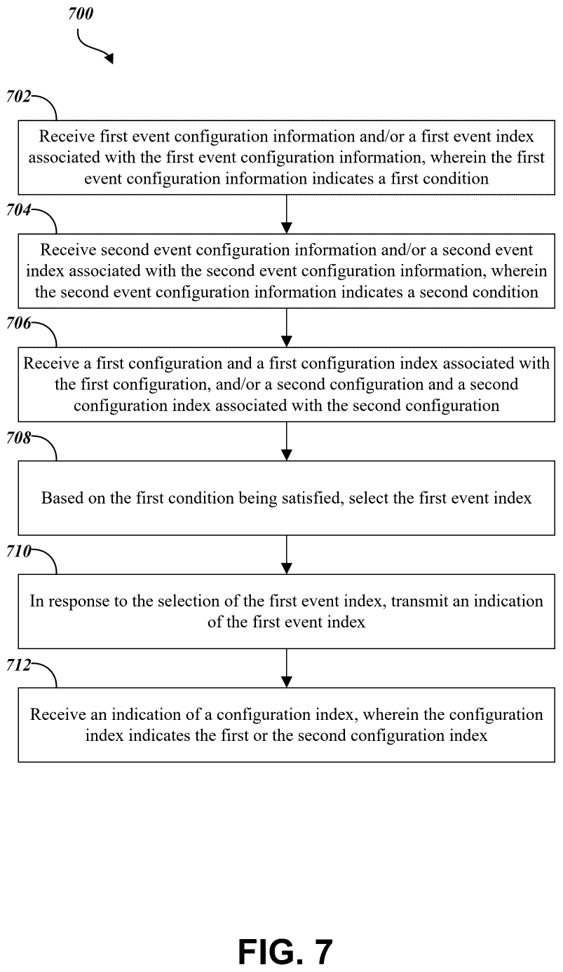

FIG. 7 is a flow diagram illustrating an example configuration 700 that may be performed by a WTRU based on event configuration information.

At 702, the WTRU may receive first event configuration information and/or a first event index associated with the first event configuration information. The first event configuration information may indicate a first condition.

At 704, the WTRU may receive second event configuration information and/or a second event index associated with the second event configuration information. The second event configuration information may indicate a second condition.

At 706, the WTRU may receive a first configuration and a first configuration index associated with the first configuration, and/or a second configuration and a second configuration index associated with the second configuration.

At 708, the WTRU may, based on the first condition being satisfied, select the first event index.

At 710, the WTRU may, in response to the selection of the first event index, transmit an indication of the first event index.

At 712, the WTRU may receive an indication of a configuration index. The configuration index may indicate the first or the second configuration index.

Although features and elements described herein are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, NR or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to:
receive:
first event configuration information and a first event index associated with the first event configuration information, wherein the first event configuration information indicates a first condition; and
second event configuration information and a second event index associated with the second event configuration information, wherein the second event configuration information indicates a second condition;
receive a first configuration and a first configuration index associated with the first configuration, and a second configuration and a second configuration index associated with the second configuration;
based on the first condition being satisfied, select the first event index;
in response to the selection of the first event index, transmit an indication of the first event index; and
after transmission of the indication of the first event index, receive an indication of a configuration index, wherein the configuration index indicates the first or the second configuration index.

2. The WTRU of claim 1, wherein the first condition comprises a data arrival condition and a measurement condition, and wherein the processor is further configured to:
determine that data is available for transmission and that a trigger event has occurred, wherein the first condition is satisfied based on the determination that the data is available for transmission and that the trigger event has occurred.

3. The WTRU of claim 1, wherein the first event configuration information, the first event index, the second event configuration information, the second event index, the first configuration, the first configuration index, the second configuration, and the second configuration index are received via a first control signaling protocol, and wherein the indication of the configuration index is received via a second control signaling protocol.

4. The WTRU of claim 1, wherein the first condition comprises at least one of: an amount of data in a buffer of the WTRU is greater than a threshold, a time remaining for buffering data is less than a first threshold, or a reference signal received power (RSRP) value is greater than a second threshold.

5. The WTRU of claim 1, wherein the processor is further configured to:
determine that data is available for transmission; and
transmit at least a portion of the data available for transmission using a configuration, from the first or second configurations, associated with the received indication of the configuration index.

6. The WTRU of claim 3, wherein the first control signaling protocol is a dedicated radio resource control (RRC) signaling protocol, and wherein the second control signaling protocol is a MAC control element (CE) protocol.

7. The WTRU of claim 5, wherein the configuration indicates an L1/L2 configuration.

8. The WTRU of claim 1, wherein the configuration index indicates the first configuration, and wherein the processor is further configured to apply the first configuration.

9. The WTRU of claim 1, wherein the first event index indicates an event ID, and wherein the transmission of the indication of the first event index comprises an indication of the event ID.

10. A method comprising:
receiving:
first event configuration information and a first event index associated with the first event configuration information, wherein the first event configuration information indicates a first condition; and
second event configuration information and a second event index associated with the second event configuration information, wherein the second event configuration information indicates a second condition;
receiving a first configuration and a first configuration index associated with the first configuration, and a second configuration and a second configuration index associated with the second configuration;
based on the first condition being satisfied, selecting the first event index;
in response to the selection of the first event index, transmitting an indication of the first event index; and
after transmitting the indication of the first event index, receiving an indication of a configuration index, wherein the configuration index indicates the first or the second configuration index.

11. The method of claim 10, wherein the first condition comprises a data arrival condition and a measurement condition, and wherein the method further comprises:
determining that data is available for transmission and that a trigger event has occurred, wherein the first condition is satisfied based on the determination that the data is available for transmission and that the trigger event has occurred.

12. The method of claim 10, wherein the first event configuration information, the first event index, the second event configuration information, the second event index, the first configuration, the first configuration index, the second configuration, and the second configuration index are received via a first control signaling protocol, and wherein the indication of the configuration index is received via a second control signaling protocol.

13. The method of claim 10, wherein the first condition comprises at least one of: an amount of data in a buffer of a WTRU is greater than a threshold, a time remaining for buffering data is less than a first threshold, or a reference signal received power (RSRP) value is greater than a second threshold.

14. The method of claim 10, wherein the method further comprises:
determining that data is available for transmission; and
transmitting at least a portion of the data available for transmission using a configuration, from the first or second configurations, associated with the received indication of the configuration index.

15. The method of claim 12, wherein the first control signaling protocol is a dedicated radio resource control (RRC) signaling protocol, and wherein the second control signaling protocol is a MAC control element (CE) protocol.

16. The method of claim 14, wherein the configuration indicates an L1/L2 configuration.

17. The method of claim 10, wherein the configuration index indicates the first configuration, and wherein the method further comprises applying the first configuration.

18. The method of claim 10, wherein the first event index indicates an event ID, and wherein the transmission of the indication of the first event index comprises an indication of the event ID.
